(19) United States
(12) Patent Application Publication
(10) Pub. No.: US 2010/0055424 A1
(43) Pub. Date: Mar. 4, 2010

(54) PRINTING APPARATUS, PRINTING METHOD, PROGRAM AND PRINTED PRODUCT

(75) Inventors: Seishin Yoshida, Azumino-shi (JP); Takashi Oyanagi, Matsumoto-shi (JP); Akio Ito, Chino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/549,316

(22) Filed: Aug. 27, 2009

(30) Foreign Application Priority Data
Aug. 28, 2008 (JP) 2008-219135

(51) Int. Cl. B32B 3/10; B41J 29/38

(52) U.S. Cl. 428/209; 428/195.1; 347/6

(57) ABSTRACT

A printing apparatus, a printing method, an application program and a printing medium are disclosed. The printing apparatus is coupled to a control circuit which with the help of the application program, controls the operation of the printing apparatus. The printing apparatus contains at least two kinds of glossy recording materials with different concentrations. The printing apparatus performs glossy printing on a printing medium by controlling the usage of the two kinds of glossy recording materials.

This application claims priority to Japanese Patent Application No. 2008-219135, filed Aug. 28, 2008, the entirety of which is incorporated by reference herein.

### BACKGROUND OF THE INVENTION

1. Technical Field

The present invention relates to a technology of printing an image by using recording materials including special glossy material with special gloss.

2. Related Art

According to the related art, after a background layer is formed on a print medium, printing is additionally performed on the background layer (for example, see JP-A-2002-530229). Such a method may be used for various printing methods. For example, in relation to an ink jet printer, after a metallic ink layer is formed on a print medium, color ink is printed on the metallic ink layer, so that metallic color with various hues can be produced.

However, when printing metallic color while restricting the special glossy effect by a certain degree, the amount of metallic ink used must be reduced. In such a case, dots of the metallic ink are visible, so a decrease in the graininess of a printed image may become a problem. Such a problem occurs not just in the ink jet printer but in various printing apparatuses.

### BRIEF SUMMARY OF THE INVENTION

An advantage of some aspects of the invention is to effectively print metallic color while allowing a special glossy effect to be compatible with fine granularity in a printed image.

One embodiment of the invention is directed to a printing apparatus for performing printing by using a plurality of glossy recording materials, the printing apparatus comprising a carriage coupled to a print head having a plurality of ejection heads, wherein the carriage is further coupled to at least one cartridge coupled to the plurality of ejection heads, wherein the cartridge contains at least two kinds of glossy recording materials having different concentrations; a control circuit couple to the carriage and the plurality of ejection heads, and configured to control the plurality of ejection heads to perform printing, using at least one of the two kinds of glossy recording materials; and wherein the control unit is further configured to control a degree of desired special glossy effect by controlling a usage of the at least two kinds of glossy recording materials.

In one aspect, the at least two kinds of glossy recording materials are comprised of a low-concentration glossy recording material and a high-concentration glossy recording material.

In another aspect, when the degree of desired special glossy effect is increased, the control unit performs the printing by decreasing the usage of low-concentration glossy recording material while increasing the usage of high-concentration glossy recording material.

In another aspect, when the degree of desired special glossy effect corresponds to an index less than or equal to a maximum achievable degree of gloss of the low-concentration glossy recording material, the control unit performs the printing by primarily using the low-concentration glossy recording material.

In another aspect, the at least two kind of glossy recording materials have reflection angle dependence after being printed on a surface of a print medium.

In another aspect, the control unit is capable of adjusting the special glossy effect by changing the usage of the high-concentration glossy recording material while maintaining the usage of the low-concentration glossy material at a constant level.

In another aspect, the at least two kinds of glossy recording materials have reflection angle dependence after being printed on a surface of a print medium.

In another aspect the at least two kinds of glossy recording materials include metal pigments, and wherein the metal pigments in one kind of glossy recording material have a density that is different from a density of another kind of glossy recording material.

Another embodiment is directed to a method for performing printing by using a plurality of glossy recording materials, the method comprising: using a control unit, performing printing by filling at least a part of a print area of a print medium with dots formed by using at least two kinds of glossy recording materials having different concentrations; and using the control unit, controlling a degree of desired special glossy effect on the print area of the print medium by controlling a usage of at least two kinds of glossy recording materials.

Another embodiment is directed to an application program on a computer system coupled to a printing apparatus, for controlling the operation of the printing apparatus to perform printing by using a plurality of glossy recording materials including a low-concentration glossy recording material and a high-concentration glossy recording material, the application program causing the computer system to execute using a control unit, printing by filling at least a part of a print area of a print medium with dots formed by using the plurality of glossy recording materials having different concentrations; and using the control unit, controlling a degree of desired special glossy effect on the print area of the print medium by controlling a usage of the plurality of glossy recording materials.

Another embodiment is directed to a printed product printed by a plurality of glossy recording materials including a low-concentration glossy recording material and a high-concentration glossy material, the printed product including a print area of a print medium, at least part of which is filled with dots formed by using at the low-concentration glossy recording material and the high-concentration glossy material.

### BRIEF DESCRIPTION OF THE DRAWINGS

The invention will be described with reference to the accompanying drawings, wherein like numbers reference like elements.

FIG. 1 is a block diagram schematically showing a configuration of a printing system according to an embodiment of the invention.

FIG. 2 is a block diagram showing a configuration of a computer serving as a printing control apparatus.

FIG. 3 is a block diagram showing a configuration of a printer.

FIG. 4 is a graph showing the difference of characteristics of the glossiness of a printed product due to difference densities of metal pigment in metallic ink.

FIG. 5 is a flowchart showing a printing process.

FIG. 6 is a graph showing a method of determining the usage amounts of low density metallic ink and high density metallic ink.

FIG. 7 is a graph showing a method of determining the usage amounts of low density metallic ink and high density metallic ink according to a modification.

FIG. 8 is a graph showing a method of determining the usage amounts of low density metallic ink and high density metallic ink according to a modification.

FIG. 9 is a graph showing a difference of characteristics of an index value regarding a special glossy effect of a printed product, which is caused by a difference of metal pigment in metallic ink.

FIG. 10 is a graph showing a difference of characteristics of an index value regarding a special glossy effect of a printed product, which is caused by a difference of metal pigment in metallic ink.

### DETAILED DESCRIPTION

### A. Outline of a Printing System

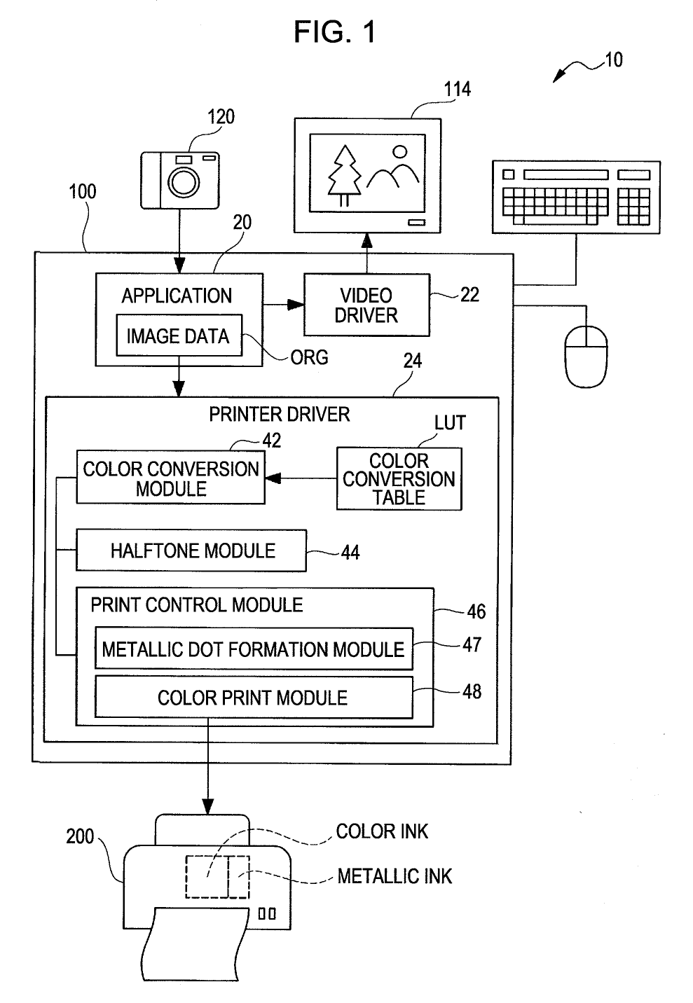

FIG. 1 is a block diagram schematically showing a printing system 10 according to an embodiment of the invention. As shown in FIG. 1, the printing system 10 includes a computer 100 serving as a printing control apparatus, and a printer 200 that prints an image under the control of the computer 100. The printing system 10 may serve as a printing apparatus in a broad sense by allowing all elements thereof to be integrally formed with each other.

The printer 200 according to the embodiment has Cyan ink, Magenta ink, Yellow ink and Black ink as color ink, and metallic ink. The metallic ink allows a special glossy effect to be produced on a printed product, and detailed description thereof will be given later. According to an embodiment, the color ink includes the black ink.

The computer 100 includes a predetermined operating system installed therein, and an application program 20 executed under the control of the operating system. The operating system has a video driver 22 and a printer driver 24. For example, if image data ORG is received from a digital camera 120 through a peripheral device interface 108, the application program 20 displays an image, which is represented by the image data ORG, on a display 114 through the video driver 22. Further, the application program 20 outputs the image data ORG to the printer 200 through the printer driver 24. The image data ORG, which is sent to the application program 20 from the digital camera 120, includes the three primary colors of red R, green G and blue B.

The application program 20 according to an embodiment, can designate a region (hereinafter, referred to as a color region), which is filled with the three primary colors of R, G and B, and a region (hereinafter, referred to as a metallic region), which is filed with metallic color, in an arbitrary region of the image data ORG The metallic region may overlap the color region. More specifically, the two regions may be designated such that a color image is formed with the metallic color used as a background color. Further, the application program 20 can designate the level of an index regarding the special glossy effect. That is, the degree of the special glossy effect of the metallic region can be designated and controlled. The index regarding the special glossy effect will be described in detail later.

The printer driver 24 includes a color conversion module 42, a halftone module 44 and a print control module 46. The print control module 46 includes a metallic dot formation module 47 and a color print module 48.

The color conversion module 42 converts RGB color components of the color region of the image data ORG into color components, such as Cyan C, Magenta M, Yellow Y and Black K, which can be expressed through the printer 200, with reference to a prepared color conversion table LUT.

The halftone module 44 performs halftone processing relative to the color-converted image data by the color conversion module 42, such that the gray scale of the image data is represented by a distribution of dots. In one embodiment, the well-known ordered dither method may be used for the halftone processing. In another embodiment, other half tone processing may be used. Further, in addition to the half tone processing method, an error diffusion method, and a tone production method by density pattern and a halftone technology may be used for the halftone processing.

The print control module 46 rearranges the halftone-processed image data in a sequence by which the image data is transmitted to the printer 200, and outputs the rearranged data to the printer 200 as print data. Further, the print control module 46 controls the printer 200 by outputting various commands such as a print start command or a print end command to the printer 200.

According to an embodiment, the print control module 46 includes the metallic dot formation module 47 and the color print module 48. The metallic dot formation module 47 forms metallic ink dots on the metallic region designated by the application program 20, and the color print module 48 forms color ink dots with respect to the halftone-processed image, that is, the image of the color region.

### B. Apparatus Configuration

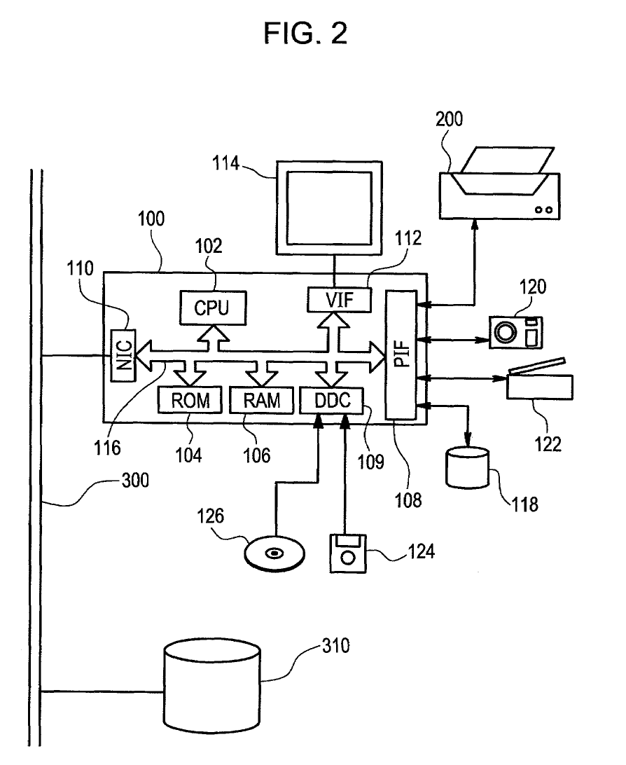

FIG. 2 is a block diagram showing a configuration of the computer 100 serving as the printing control apparatus. The computer 100 is generally known in the art and includes a CPU 102, a ROM 104, a RAM 106 and the like, which are connected with each other through a bus 116.

The computer 100 includes a disk controller 109 for reading data from a flexible disk 124, a compact disk 126 and the like, a peripheral device interface 108 for transmitting and receiving data to and from a peripheral device, and a video interface 112 for driving a display 114. The peripheral device interface 108 is connected to the printer 200 and a hard disk 118. Further, if the digital camera 120 or a color scanner 122 is connected to the peripheral device interface 108, image processing can be performed relative to images obtained through the digital camera 120 or the color scanner 122. Further, if a network interface card 110 is installed at the computer 100, the computer 100 can read data stored in a memory device 310 through a communication line 300. If image data to be printed is obtained, the computer 100 prints the image data by controlling the printer 200 through the functions of the printer driver 24.

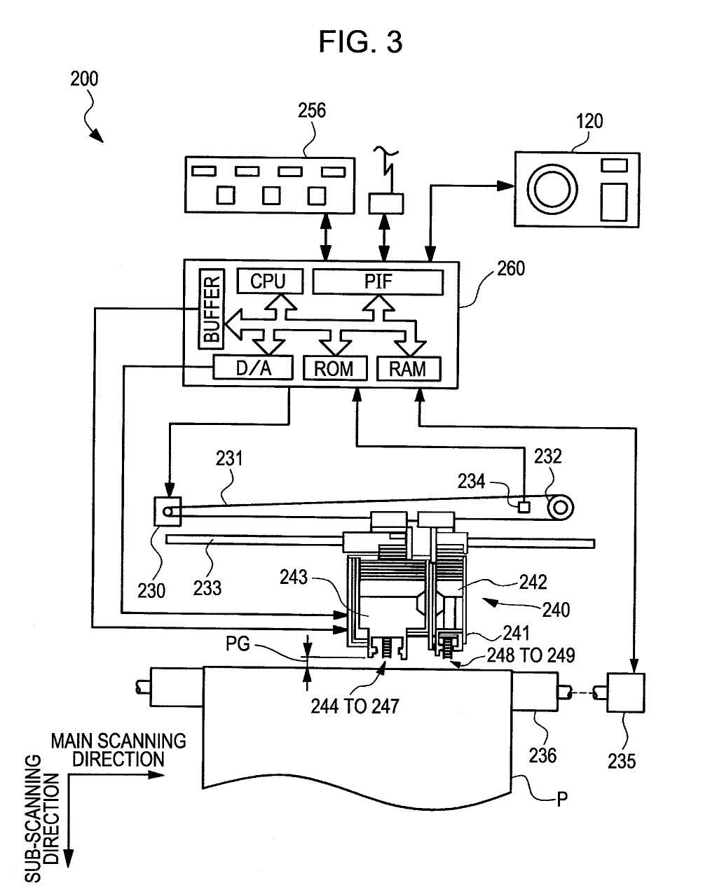

Hereinafter, the configuration of the printer 200 will be described with reference to FIG. 3. As shown in FIG. 3, the printer 200 includes a mechanism that transfers a print medium P using a sheet transfer motor 235, a mechanism that allows a carriage 240 to reciprocate in an axial direction of a platen 236 using a carriage motor 230, a mechanism that drives a print head 241 mounted on the carriage 240 to eject ink and form dots, and a control circuit 260 that controls signal exchange among the sheet transfer motor 235, the carriage motor 230, the print head 241 and a manipulation panel 256.

The mechanism, which allows the carriage 240 to reciprocate in the axial direction of the platen 236, includes a sliding shaft 233, which is installed in parallel to a shaft of the platen 236 such that the carriage 240 slidably moves, a driving belt 231 extending between a pulley 232 and the carriage motor 230, and a position sensor 234 that detects the original position of the carriage 240.

The carriage 240 includes a color ink cartridge 243 that stores the color inks such as Cyan ink C, Magenta ink M, Yellow ink Y and Black ink K. Further, the carriage 240 includes metallic ink cartridges 242 that each store two kinds of metallic inks S1 and S2. The print head 241 provided at a lower portion of the carriage 240 includes ink ejection heads 244 to 247 corresponding to the four kinds of the color inks, and ink ejection heads 248 and 249 corresponding to the two kinds of the metallic inks. The ink cartridges 242 and 243 are installed in the carriage 240 from the top to the bottom, so the inks can be supplied to the ejection heads 244 to 249 from the cartridges 242 and 243.

The control circuit 260 of the printer 200 includes the CPU, the ROM, the RAM, the peripheral device interface and the like, which are connected with each other through the bus. The control circuit 260 controls main scanning and sub-scanning operations of the carriage 240 by controlling operations of the carriage motor 230 and the sheet transfer motor 235. Further, if the print data is received from the computer 100 through the PIF, the control circuit 260 drives the ink ejection heads 244 to 249 by supplying driving signals corresponding to the print data to the ink ejection heads 244 to 249 in correspondence with the main scanning and sub-scanning operations of the carriage 240.

The printer 200 having the hardware configuration as described above drives the carriage motor 230 to allow the ink ejection heads 244 to 249 to reciprocate relative to the print medium P in the main scanning direction. Further, the printer 200 drives the sheet transfer motor 235 to move the print medium P in the sub-scanning direction. The control circuit 260 forms ink dots of appropriate colors at appropriate positions on the print medium P by driving the nozzles at proper times based on the print data corresponding to the reciprocation (main scanning) of the carriage 240 and the movement (sub-scanning) of the print medium P. In this way, the printer 200 can print a color image on the print medium P. In one embodiment, the metallic ink is contained in the detachable cartridge installed in the printer 200. However, in another embodiment the metallic ink may be contained in an ink tank provided separately from the printer 200, and the ink tank may be connected with the printer 200. In yet another embodiment, the metallic ink may be contained in a container integrally formed with the printer 200.

### C. Characteristics of Metallic Ink

As described above, in one embodiment the printer 200 in the embodiment has the metallic ink cartridge 242 that receives the two kinds of the metallic inks S1 and S2. The metallic ink allows the special glossy effect to be produced on the printed product. For example, the metallic ink may use an oil-based ink composition including metal pigments, organic solvents and resins to produce the metallic effect. In order to effectively obtain a metallic effect, in one embodiment the metal pigment includes flat plate-shaped particles. When the flat plate-shaped particle has a long diameter of X, a short diameter of Y and a thickness of Z in a plane, it is preferable that a 50% average particle diameter R50 of the particle is 0.5 μm to 3 μm, which corresponds to a diameter of a circle calculated from an area of the X-Y plane of the flat plate-shaped particles. In this embodiment, it is also preferred that a formula R50/Z>5 is satisfied. For example, the metal pigment may be formed using aluminum or an aluminum alloy and may also be formed by crushing a metal deposition film. The metal pigment included in the metallic ink may have a density of about 0.1 weight % to about 10.0 weight %. However, the metallic ink is not limited to the above composition. That is, the metallic ink may employ various compositions if the metallic ink includes special glossy material with special gloss. Further, the metallic ink has optical properties such as reflection angle dependence after the metallic ink is printed on the surface of the print medium, so the metallic ink has various appearances corresponding to different observation angles.

Further, the two kinds of the metallic inks used for the embodiment include metal pigments having densities different from each other. In one embodiment, the metallic ink including the metal pigment having a relatively high density will be referred to as high density metallic ink, and the metallic ink including the metal pigment having a relatively low density will be referred to as low density metallic ink. In one embodiment, the low density metallic ink S1 has a composition of aluminum pigment of 0.5 weight %, glycerin of 20 weight %, triethyleneglycol monobutyl ether of 40 weight %, and BYK-UV3500 of 0.1 weight % (manufactured by BYK Chemie of Japan). The high density metallic ink S2 has a composition of the aluminum pigment of about 1.5 weight %, the glycerin of about 20 weight %, the triethyleneglycol monobutyl ether of about 40 weight %, and the BYK-UV3500 of about 0.1 weight %.

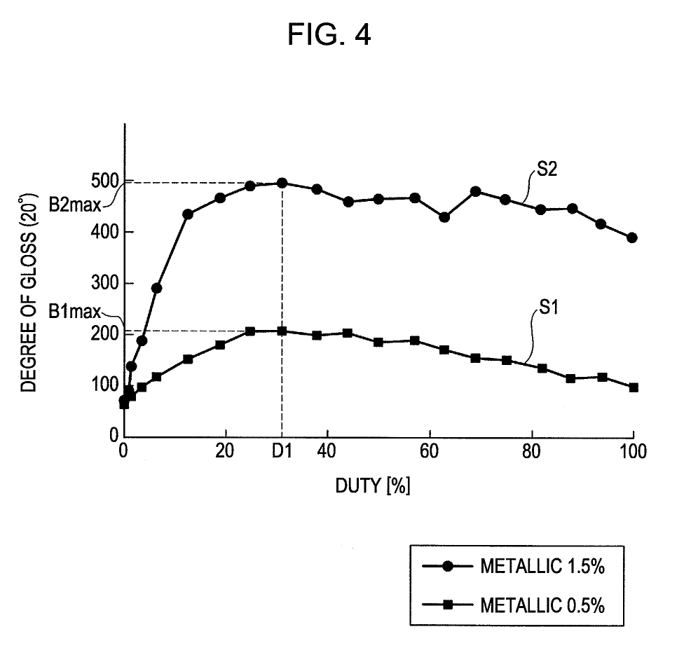

Hereinafter, the difference in characteristics between the low density metallic ink S1 and the high density metallic ink S2 will be described with reference to FIG. 4. FIG. 4 is a graph showing the glossiness (incidence angle is 20°) of a printed product as a function of a duty, which represents a ratio of dots occupied in a print region, when performing printing by using the low density metallic ink S1 and the high density metallic ink S2. As shown in FIG. 4, in the case of using the low density metallic ink S1, as the duty is increased from zero, the glossiness is increased. When the duty has a value of D1, the glossiness reaches the maximum value B1max (about 200) of the low density ink. Then, as the duty is increased more, the glossiness is significantly reduced. In the case of using the high density metallic ink S2, as the duty is increased from zero, the glossiness is increased with a higher slope as compared with the case of using the low density metallic ink S1. When the duty has the value of D1, the glossiness reaches the maximum value B2max (about 500) of the high density ink. Then, as the duty is increased more, the glossiness is slightly reduced. As described above, there is a large difference in the glossiness of the printed product depending on the amount of the metal pigment included in the metallic inks S1 and S2.

Further, the glossiness may be represented by one index regarding the special glossy effect of the metallic region. There are exceptions, but the special glossy effect is increased as the glossiness is increased. That is, as it can be seen from FIG. 4, the special glossy effect is increased using the metallic ink including the metal pigment with the high density and significantly varies depending on the duty, as compared with the case of using the metallic ink including the metal pigment with the low density. In this regard, when printing using the metallic ink including the metal pigment with the high density, the special glossy effect can be significantly increased. However, when performing printing in which the special glossy effect is restricted, the duty is reduced and the dots of the metallic ink are visible, so the fine granularity of the printed image may be reduced. When printing using the metallic ink including the metal pigment with the low density, the special glossy effect cannot be significantly increased. However, when performing printing in which the special glossy effect is restricted, the dots of the metallic ink are not easily visible and the duty is relatively large, so the fine granularity of the printed image may be improved.

### D. Printing Process

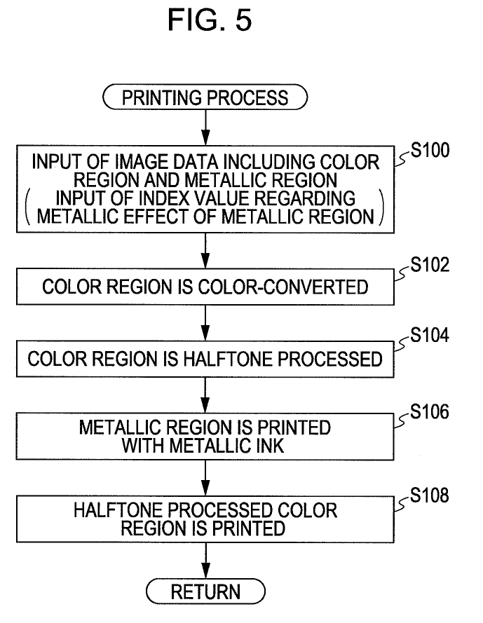

Hereinafter, the printing process performed by the printer driver 24 under the control of the computer 100 will be described. FIG. 5 is a flowchart showing the printing process according to one embodiment. If the printing process starts, the computer 100 receives image data including the color region and the metallic region from the application program 20 through the printer driver 24 (Step S100). In addition, the computer 100 receives an index value regarding the special glossy effect of the metallic region. The received index value may be set in advance, or may be selected by a user through the application program 20. According to one embodiment, the index value represents the glossiness. For example, the computer 100 receives an input with the glossiness having a value of 300. In another embodiment, the computer 100 may receive a ratio with respect to the maximum value of the index value or a gray scale number representing the degree of the special glossy effect, instead of the index value.

After the image data is received, the computer 100 converts the RGB image data to CMYK image data with respect to the color region of the image data (Step S1102). After the CMYK image data is obtained, the computer 100 performs halftone processing by using the halftone module 44 to generate data which can be transmitted to the printer 200 (Step S104). After the halftone processing, the computer 100 prints the metallic region included in the image data, which is received in Step S100, by controlling the printer 200 through the metallic dot formation module 47 (Step S106). If the metallic region is completely printed, the computer 100 controls the printer 200 through the color print module 48 so that the halftone-processed color region is printed (Step S108).

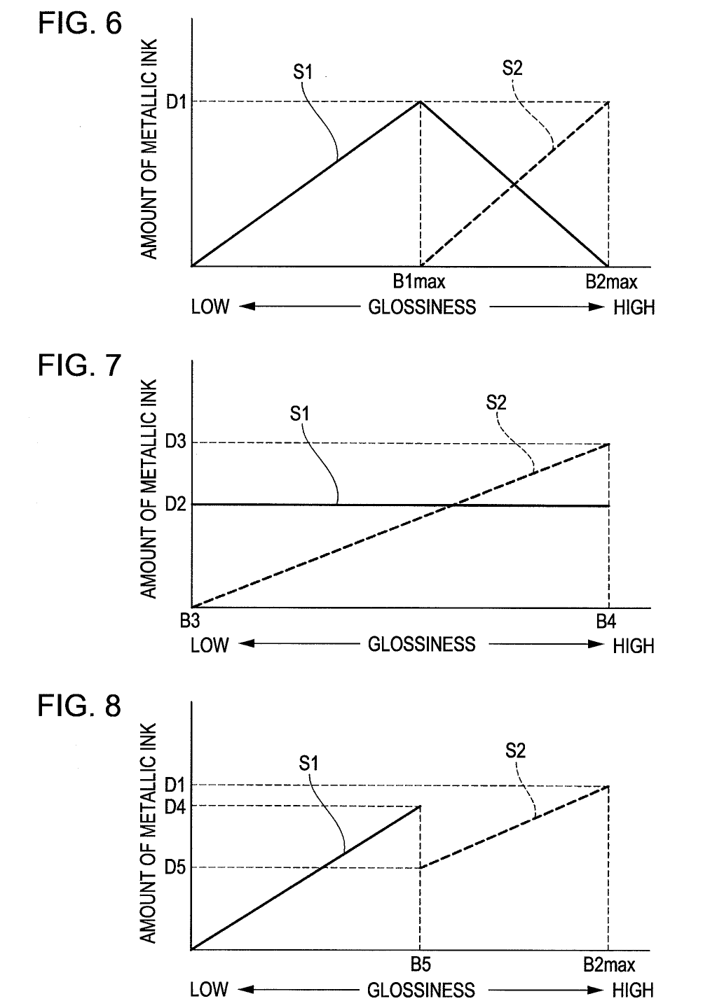

The printing process will be described in detail with reference to FIG. 6. FIG. 6 is a graph showing the amount of the low density metallic ink S1 and the high density metallic ink S2 which are used for printing the metallic region. As shown in FIG. 6, when the desired glossiness received in Step S100 is equal to or less than the maximum gloss value B1max of the low density ink, the computer 100 performs printing by using only the low density metallic ink S1 corresponding to the received glossiness. When the desired glossiness received in Step S100 corresponds to the maximum gloss value B1max of the low density ink, the amount of the low density metallic ink S1 used corresponds to the duty D1 shown in FIG. 4.

Further, when the desired glossiness received in Step S100 is larger than the maximum gloss value B1max of the low density ink, the computer 100 performs printing by using the low density metallic ink S1 and the high density metallic ink S2. More specifically, as the degree of desired glossiness received in Step S100 is increased, the amount of the low density metallic ink S1 used is reduced and the amount the high density metallic ink S2 used is increased. In the event when the degree of desired glossiness received in Step S100 corresponds to the maximum gloss value B2max of the high density ink, the amount of the high density metallic ink S2 used corresponds to the duty D1 and the amount of the low density metallic ink S1 used is zero.

The amount of the ink used may be easily determined by using a table in which the index value regarding the special glossy effect corresponds to the usage amounts of the low density metallic ink S1 and the high density metallic ink S2. Further, the arrangement of dots formed by the low density metallic ink S1 and dots formed by the high density metallic ink S2 may be determined by the combination of the usage amounts of the low density metallic ink S1, the high density metallic ink S2, and a distribution of the two kinds of dots.

In one embodiment, when the desired glossiness is equal to or larger than the maximum gloss value B1max of the low density ink is received, the duty of the low density metallic ink S1 and the high density metallic ink S2 is equal to the constant duty D1 through the sum of the two duties. However, the embodiments of the invention are not limited thereto. That is, the duty may not necessarily be constant. For example, the duty may be increased as the desired glossiness is increased. Further, when the desired glossiness is equal to or less than the maximum gloss value B1max of the low density ink, even though the high density metallic ink S2 is used at the same time, no problem occurs if the low density metallic ink S1 is mainly used.

When performing the printing within the range of the index regarding the special glossy effect, the desired degree of glossiness may not be obtained by using the low density metallic ink S1, by which the fine granularity of the printed image may be easily ensured. In such a case, the metallic region is printed by combining the low density metallic ink S1 and the high density metallic ink S2. At this time, as the received index regarding the special glossy effect is increased, the amount of the low density metallic ink S1 used is reduced and the use amount of the high density metallic ink S2 is increased. More specifically, when performing printing in which the special glossy effect is restricted, the duty of the high density metallic ink S2 is reduced. In this situation, the desired graininess of the printed image may not be achieved. However, as the special glossy effect is increased, the duty of the high density metallic ink S2 is increased, so the graininess of the printed image does not matter. Thus, as the required special glossy effect is reduced, printing is performed by mainly using the low density metallic ink S1 by which the fine granularity may be easily ensured. Further, as the required special glossy effect is increased, printing is performed mainly using the high density metallic ink S2 having a large special glossy effect. Consequently, the metallic color can be properly printed while preventing the fine granularity of the printed image from being reduced.

When performing the printing within the range of the index regarding the special glossy effect which can be obtained using the low density metallic ink S1 by which the fine granularity of the printed image may be easily ensured, only the low density metallic ink S1 is used. Thus, the metallic color can be properly printed while ensuring the fine granularity of the printed image.

In one embodiment, the maximum gloss value B1max of the low density ink is employed as a threshold value and the usage amounts of the low density metallic ink S1 and the high density metallic ink S2 vary depending on the desired glossiness. However, the threshold value is not limited to the maximum gloss value B1max of the low density ink. That is, the threshold value may be properly set by taking the duty of the metallic ink and the graininess of the printed image into consideration. For example, when the graininess is not a serious problem in a range of a low duty, the threshold value may be set to be less than the maximum gloss value B1max of the low density ink.

In another embodiment, the printer 200 can store the two kinds of the metallic inks including the metal pigment with densities different from each other, and the computer 100 uses one or a combination of the two kinds of the metallic inks in response to the special glossy effect required for the printed product, so that the fine granularity of the printed image can be compatible with the special glossy effect. However, metallic ink to be used is not limited to the two kinds of the metallic inks. For example, the printer 200 may store three kinds or more of metallic inks. In such a case, the computer 100 may use one or M combinations (M denotes an integer of 2 or more) of N kinds of the metallic inks (N denotes an integer of 3 or more) in response to the special glossy effect required for the printed product. Thus, the special glossy effect and the fine granularity can be controlled in a wider range, so that printing can be performed to obtain desired special glossy effect while properly ensuring the fine granularity.

In another embodiment, the computer 100 prints the metallic region by varying the amount of the low density metallic ink S1 used depending on the special glossy effect required for the printed product. However, a predetermined amount of the low density metallic ink S1 may be used in a predetermined range (in FIG. 7, glossiness of B3 to B4) of the required special glossy effect. For example, as shown in FIG. 7, the low density metallic ink S1 corresponding to a duty D2 may be always used and the amount of the high density metallic ink S2 used may be changed in a range of from zero to a duty D3 according to the required special glossy effect. The predetermined range may be properly set. For example, the predetermined range may be set between the maximum gloss value B1max of the low density ink and the maximum gloss value B2max of the high density ink as shown in FIG. 6. Thus, the fine granularity can be ensured using the low density metallic ink S1, so that the fine granularity can be compatible with the special glossy effect.

In another embodiment, the computer 100 uses one or a combination of the two kinds of the metallic inks in response to the special glossy effect required for the printed product, so that the fine granularity of the printed image can be compatible with the special glossy effect. However, only one of the two kinds or more of the metallic inks stored in the printer 200 may be always used. For example, as shown in FIG. 8, when the input glossiness is equal to or less than a threshold value B5, the metallic region may be printed only with the low density metallic ink S1. However, when the input glossiness is larger than the threshold value B5, the metallic region may be printed only with the high density metallic ink S2. In the case of using only the high density metallic ink S2, if the amount of the high density metallic ink S2 used exceeds the amount corresponding to a duty D5 smaller than the duty D1, the fine granularity can be compatible with the special glossy effect in a case in which the graininess of the printed image does not matter.

In another embodiment, the glossiness is used as the index regarding the special glossy effect. However, the index regarding the special glossy effect is not limited thereto. That is, various indexes can be used. For example, an index value In1 regarding the special glossy effect, which is expressed by Equation 1 below, may be used. Further, an index value In2 regarding the special glossy effect, which is expressed by Equation 2 below, may be used.

$$ln 1 = \frac{2.69 {( {L}_{1}^{*} - {L}_{3}^{*} )}^{1.11}}{{L}_{2}^{* 0.86}} \qquad Equation 1$$

L*₁: lightness when a light receiving angle is 30° (irradiation angle is −45°)
L*₂: lightness when a light receiving angle is 0° (irradiation angle is −45°)
L*₃: lightness when a light receiving angle is −65° (irradiation angle is −45°)

$$ln 2 = \frac{3 ( {L}_{1}^{*} - {L}_{3}^{*} )}{{L}_{2}^{*}} \qquad Equation 2$$

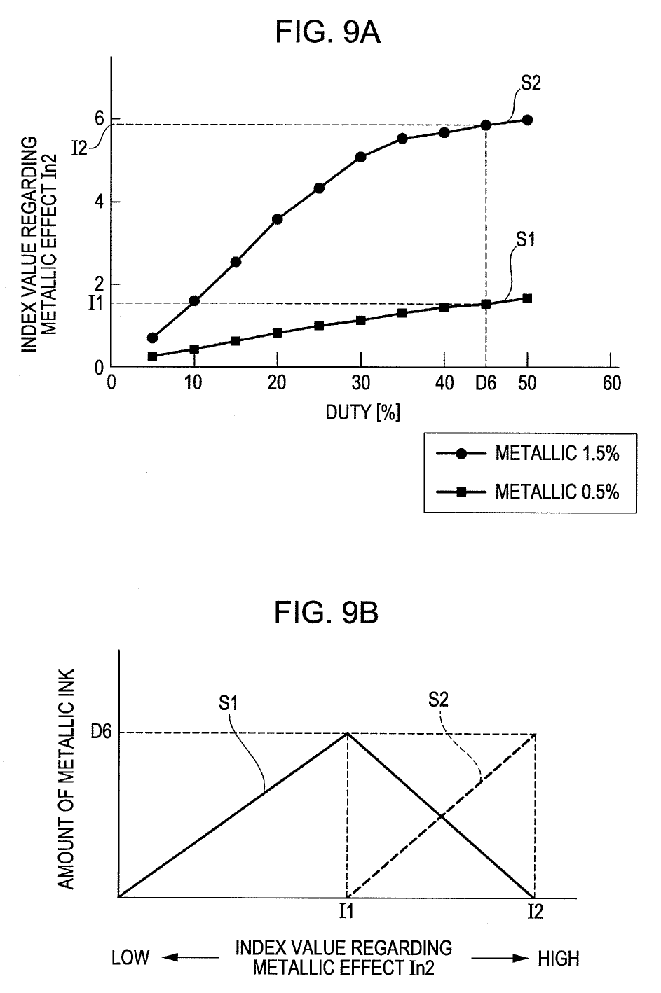

FIG. 9A is a graph showing the relationship between the density of metal pigment and the index value In2 regarding the special glossy effect. As shown in FIG. 9A, in the case of using the low density metallic ink S1, as the duty is increased, the index value In2 regarding the special glossy effect is also increased. However, the slope of the increase in the index value In2 is gentle and the index value In2 does not reach 2 even if the duty has a value of 50. Meanwhile, in the case of using the high density metallic ink S2, as the duty is increased, the index value In2 regarding the special glossy effect is also increased. However, the slope of increase in the index value In2 is steep as compared with the case of using the low density metallic ink S1. Further, when the duty has a value of 50, the index value In2 reaches about 6. Meanwhile, referring to FIG. 4 showing the relationship between the index value (glossiness) and the duty, the peak of the index value (glossiness) is indicated by the duty D1, and the index value (glossiness) is reduced if the duty exceeds the peak. However, the peak of the index value In2 regarding the special glossy effect does not occur in the duty range of 5 to 50 shown in FIG. 9A.

When the index value In2 regarding the special glossy effect is received in Step S100, the computer 100 may determine the usage amounts of the low density metallic ink S1 and the high density metallic ink S2 based on FIG. 9B (Step S106). That is, when the index value In2 regarding the special glossy effect is equal to or less than a value I1 (which corresponds to a duty D6 of the low density metallic ink S1), only the low density metallic ink S1 is used. Further, when the index value In2 regarding the special glossy effect is positioned between the value I1 and a value I2 (which corresponds to a duty D6 of the high density metallic ink S2), the amount of the low density metallic ink S1 used may be gradually reduced and the amount of the high density metallic ink S2 used may be increased. Determination of the usage amounts of the low density metallic ink S1 and the high density metallic ink S2 are not limited to the example of FIG. 9B. That is, the determination of the usage amounts of the inks S1 and S2 may be performed in various ways, similarly to the embodiment in which the glossiness is employed as the index value.

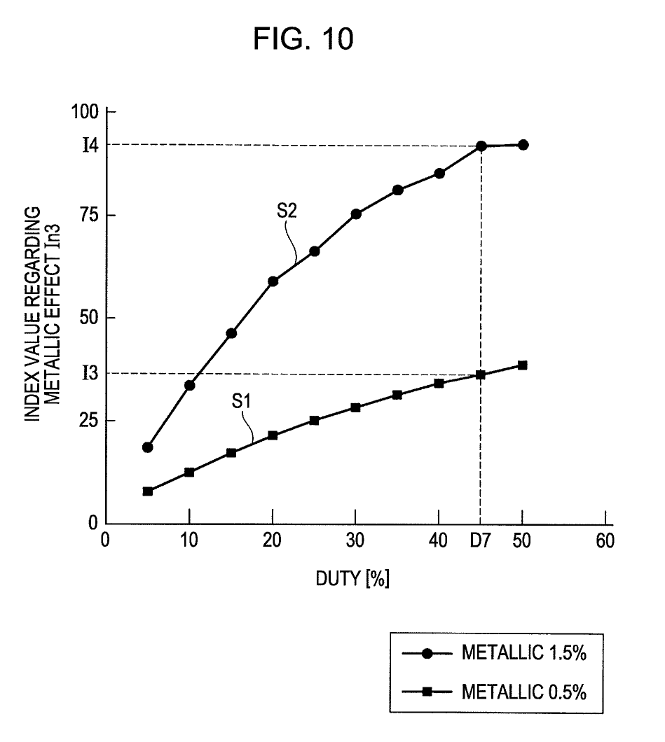

For example, an index value In3 regarding the special glossy effect, which is expressed by Equation 3 below, may be used as an index value regarding the special glossy effect. FIG. 10 is a graph showing the relationship between the density of metal pigment and the index value In3 regarding the special glossy effect. The relation shown in FIG. 10 is similar to the relation shown in FIG. 9A, so the usage amounts of the low density metallic ink S1 and the high density metallic ink S2 may be determined similarly to the case of using the index value In2 regarding the special glossy effect.

In3=L*₁−L*₃ Equation 3

In another embodiment, the printing system 10 (printing apparatus in a broad sense) including the computer 100 and the printer 200 performs the printing process as shown in FIG. 5. However, the CPU of the control circuit 260 of the printer 200 may perform printing process equal to the printing process. Thus, image data received from a digital camera and various memory cards and the like can be properly printed through the printer 200, without using the computer 100.

In another embodiment, the printer 200 is a serial ink jet printer that forms ink dots by ejecting ink droplets on the print medium P while moving the ink ejection heads 244 to 249. However, the printing scheme is not limited thereto. For example, the invention can be applied to a printer, in which ink ejection heads are arranged over a width of the print medium P, and a laser printer that forms dots by attaching toner powder of each color on the print medium using static electricity, instead of ejecting ink droplets. Further, when the invention can be applied to the laser printer, toner powder including metal pigment and the like is used instead of metallic ink. In addition, the invention can be properly applied to a press using a plate.

The application program or functions described in this application may be implemented as software code to be executed by one or more processors using any suitable computer language such as, for example, Java, C++ or assembly using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of functions disclosed in embodiments of the present invention. Based on the disclosure and teachings provided herein, a person of ordinary skill in the art will appreciate other ways and/or methods to implement the present invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

The embodiment of the invention has been described. However, the embodiment of the invention is not limited thereto. That is, various modifications can be made within the scope of the invention. For example, the invention can be realized in the form of a printing method, a program, a storage medium, a printed product and the like, as well as the printing apparatus.

What is claimed is:

1. A printing apparatus for performing printing by using a plurality of glossy recording materials, the printing apparatus comprising:
a carriage couple to a print head having a plurality of ejection heads, wherein the carriage is further coupled to at least one cartridge coupled to the plurality of ejection heads, wherein the cartridge contains at least two kinds of glossy recording materials having different concentrations;
a control circuit couple to the carriage and the plurality of ejection heads, and configured to control the plurality of ejection heads to perform printing, using at least one of the two kinds of glossy recording materials; and
wherein the control unit is further configured to control a degree of desired special glossy effect by controlling a usage of the at least two kinds of glossy recording materials.

2. The printing apparatus of claim 1, wherein the at least two kinds of glossy recording materials are comprised of a low-concentration glossy recording material and a high-concentration glossy recording material.

3. The printing apparatus of claim 2, wherein when the degree of desired special glossy effect is increased, the control unit performs the printing by decreasing the usage of low-concentration glossy recording material while increasing the usage of high-concentration glossy recording material.

4. The printing apparatus of claim 2, wherein when the degree of desired special glossy effect corresponds to an index less than or equal to a maximum achievable degree of gloss of the low-concentration glossy recording material, the control unit performs the printing by primarily using the low-concentration glossy recording material.

5. The printing apparatus of claim 4, wherein the index is proportioned to a ratio of light-receiving angle-dependent lightness values.

6. The printing apparatus of claim 2, wherein the control unit is capable of adjusting the special glossy effect by changing the usage of the high-concentration glossy recording material while maintaining the usage of the low-concentration glossy material at a constant level.

7. The printing apparatus of claim 2, wherein the at least two kind of glossy recording materials have reflection angle dependence after being printed on a surface of a print medium.

8. The printing apparatus of claim 2, wherein the at least two kind of glossy recording material include metal pigments, and wherein the metal pigments in one kind of glossy recording material have a density that is different from a density of another kind of glossy recording material.

9. A method for performing printing by using a plurality of glossy recording materials, the method comprising:
using a control unit, performing printing by filling at least a part of a print area of a print medium with dots formed by using at least two kinds of glossy recording materials having different concentrations; and
using the control unit, controlling a degree of desired special glossy effect on the print area of the print medium by controlling a usage of at least two kinds of glossy recording materials.

10. An application program on a computer system coupled to a printing apparatus, for controlling the operation of the printing apparatus to perform printing by using a plurality of glossy recording materials including a low-concentration glossy recording material and a high-concentration glossy recording material, the application program causing the computer system to execute:
using a control unit, printing by filling at least a part of a print area of a print medium with dots formed by using the plurality of glossy recording materials having different concentrations; and
using the control unit, controlling a degree of desired special glossy effect on the print area of the print medium by controlling a usage of the plurality of glossy recording materials.

11. A printed product printed by a plurality of glossy recording materials including a low-concentration glossy recording material and a high-concentration glossy material, the printed product including a print area of a print medium, at least part of which is filled with dots formed by using at the low-concentration glossy recording material and the high-concentration glossy material.

12. The printed product of claim 11, wherein the plurality of glossy recording materials include metal pigments, and wherein the metal pigments in one kind of glossy recording material have a density that is different from a density of another kind of glossy recording material.

13. The printed product of claim 11, wherein the plurality of glossy recording materials have reflection angle dependence after being printed on a surface of a print medium.
